(19) United States
(12) Patent Application Publication
(10) Pub. No.: US 2001/0054696 A1
(43) Pub. Date: Dec. 27, 2001

(54) Mode-locked laser infrared detection card and method

(76) Inventors: Aleksander Rebane, Bozeman, MT (US); Charles W. Spangler, Livingston, MT (US)

Correspondence Address: MORGAN, LEWIS & BOCKIUS, 1800 M STREET NW, WASHINGTON, DC, 20036-5869, US

(21) Appl. No.: 09/834,727

(22) Filed: Apr. 16, 2001

Related U.S. Application Data
(60) Provisional application No. 60/197,674, filed on Apr. 17, 2000.

(51) Int. Cl. G01T 5/00

(52) U.S. Cl. 250/472.1; 250/483.1; 250/486.1; 430/495.1; 427/164

(57) ABSTRACT

An apparatus and method of detection and visualization of an infrared laser beam using an optically transparent or opaque solid medium doped with at least one active chromophore dye molecule to provide conversion of infrared radiation to visible light by means of two or three-photon absorption followed by emission of a visible photon is provided. A method of verifying mode-lock in mode-locked infrared laser sources and measuring the temporal and spatial shape of ultra short laser pulses having pulse durations between a few femtoseconds and hundreds of picoseconds is also provided.

This application claims the benefit of U.S. Provisional Application No. 60/197,674, filed Apr. 17, 2000, which is hereby incorporated by reference in its entirety.

### FIELD OF THE INVENTION

The present invention relates generally to detection and visualization of infrared laser beams using a medium doped with at least one active chromophore dye molecule to provide conversion of infrared radiation to visible light. This invention also relates to a method of verifying mode-lock in mode-locked infrared laser sources, and to measurement of the temporal and spatial shape of ultra short laser pulses having pulse durations between a few femtoseconds and hundreds of picoseconds.

### BACKGROUND OF THE INVENTION

Infrared laser sources find application in many diverse technologies such as, for example, laser-induced fluorescence microscopy, optical communication systems, optical data storage, etc. Mode-locked infrared lasers are particularly useful in applications where it is necessary to produce very short pulses of light. Mode-lock in a laser can occur when the standing wave conditions in the laser cavity are locked in phase such that they produce a very short duration light pulse corresponding to when the oscillation modes add constructively, and no light pulse corresponding to when the oscillation modes interfere destructively.

In many instances it would be useful to visualize the path of an infrared laser beam in order to align an intended target with the laser beam or to ensure the laser is operating in a mode-locked state. However, because infrared light is invisible to the unaided human eye, it is impossible to directly observe a beam produced by an infrared laser, making it difficult to precisely align an infrared laser beam with an intended target. Further, also because infrared light is not visible to the unaided human eye, it has heretofore been difficult to determine when a mode-lock infrared laser source is operating in a non-mode-locked state.

Accordingly, a need exists for an infrared laser beam detection apparatus for visualizing the position, shape and relative intensity of an infrared laser beam without obstructing the beam from arriving at its target. Further, a need exists for an infrared laser mode-lock detector that will allow the user to visually monitor the performance of lasers to determine if the laser is operating in a mode-lock state.

### SUMMARY OF THE INVENTION

A method of making an infrared detection medium is provided. A polymer and at least one chromophore dye is dissolved in a solvent to form a chromophore dye/polymer/solvent mixture. The resulting mixture is placed onto a surface to substantially evaporate the solvent and form a substantially dry chromophore dye containing polymer film. The chromophore may be any chromophore or combination of chromophores selected from the group consisting of a Type 1 chromophore, a Type 2 chromophore, a Type 3 chromophore, and a Type 4 chromophore.

A method of making a substantially transparent infrared detection medium is also provided. The method includes the additional steps of pressing at least a portion of the substantially dry polymer film between first and second transparent substrates and heating the substrates to a temperature below the polymer melting temperature until the polymer film adheres to the substrates.

A method of making a substantially opaque infrared detection medium is also provided. The method includes the additional steps of layering one or more layers of the substantially dry polymer film between first and second transparent substrates and heating the substrates to a temperature above the polymer melting temperature until the chromophore dye/polymer mixture undergoes a separation of phases. Alternatively, the method includes the additional step of adding scattering beads to the chromophore dye/polymer/solvent solution.

A method of using an infrared laser detection card having an opaque region for visibly detecting infrared radiation to detect mode-lock in a mode-lock infrared laser is also provided. The method includes inserting the opaque region of the card into the beam path of the infrared laser and observing the opaque region of the card to determine if the laser is operating in a mode-lock state.

An infrared detection card having a substantially transparent region for visibly detecting infrared radiation and/or a substantially opaque region for visibly detecting infrared radiation is also provided. The infrared detection card may be mounted on a substrate and may include laser safety warning information.

A further method of forming an infrared laser detection card is also provided. A chromophore is combined with a monomer to form a mixture. The mixture may then be polymerized to form a solid. The resulting solid may then be hot-pressed to form the infrared laser detection card.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 illustrates a Type 1 chromophore in accordance with a preferred embodiment of the present invention.

FIG. 2 illustrates a Type 2 chromophore in accordance with a preferred embodiment of the present invention.

FIG. 3 illustrates a Type 3 chromophore in accordance with a preferred embodiment of the present invention.

FIG. 4 illustrates a Type 4 chromophore in accordance with a preferred embodiment of the present invention.

FIG. 5 illustrates a mode-locked laser infrared detection card in accordance with a preferred embodiment of the present invention.

FIG. 6 illustrates a sectional view of active chromophore-containing medium pressed between glass slides in accordance with the principles of the present invention.

FIG. 7 illustrates an exemplary print layout for an infrared detection card in accordance with a preferred embodiment of the present invention.

### DETAILED DESCRIPTION OF THE PREFERRED EMBODIMENT(S)

The present invention will be described primarily in relation to an infrared laser beam visualization card capable of detecting mode-lock operation of a laser and making an infrared laser beam appear visible to the unaided human eye. However, as will be appreciated by those skilled in the art, the present invention is not so limited and may be applied to any type of device or apparatus where it is useful to visualize an infrared laser beam or detect mode-lock laser operation.

In accordance with a preferred embodiment of the present invention, an apparatus and method is provided for visualizing an infrared laser beam using an appropriate chromophore compound to absorb two or three photons of infrared light and fluoresce light in the visible spectrum. Two and three-photon excitation of a chromophore compound are processes in which two or three distinct photons of the same or different energies are absorbed by the chromophore, causing excitation from ground state to a higher energy state via a virtual intermediate state having a nearly infinitely short duration. Unlike the intermediate state, the lifetime of the final excited state is finite. After a short time period (on the order of about one nanosecond) the excited chromophore molecule will return to a ground state and, in the process of returning to a ground state, it will emit a photon of light in the visible spectrum. Thus, the process of two or three-photon absorption followed by fluorescence in the visible spectrum enables invisible infrared light to be converted into visible light, allowing for visualization of an infrared beam when it is incident on regions of a material containing the chromophore.

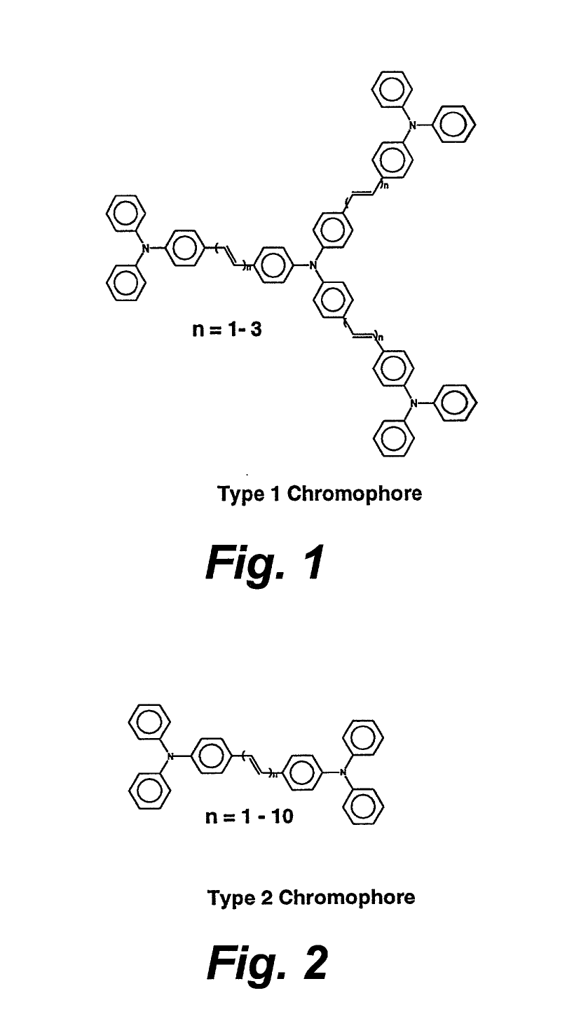

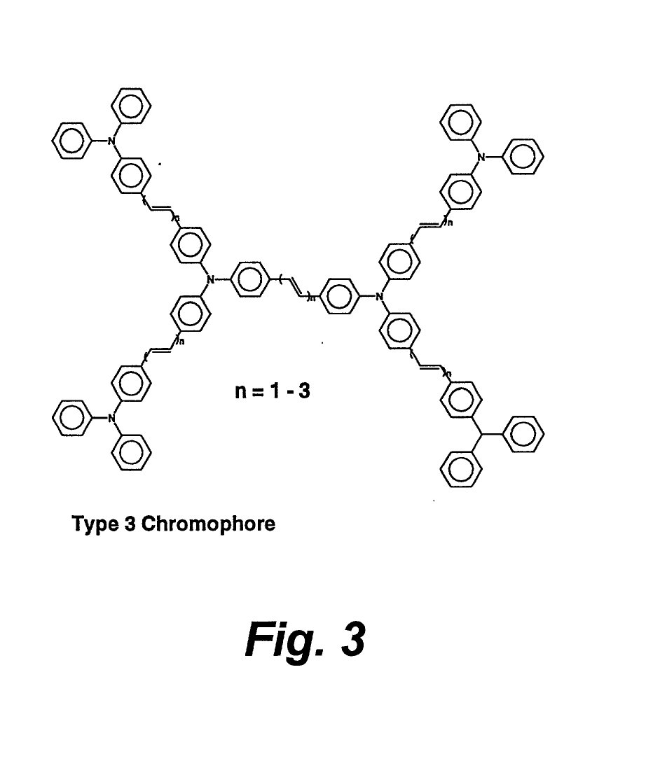

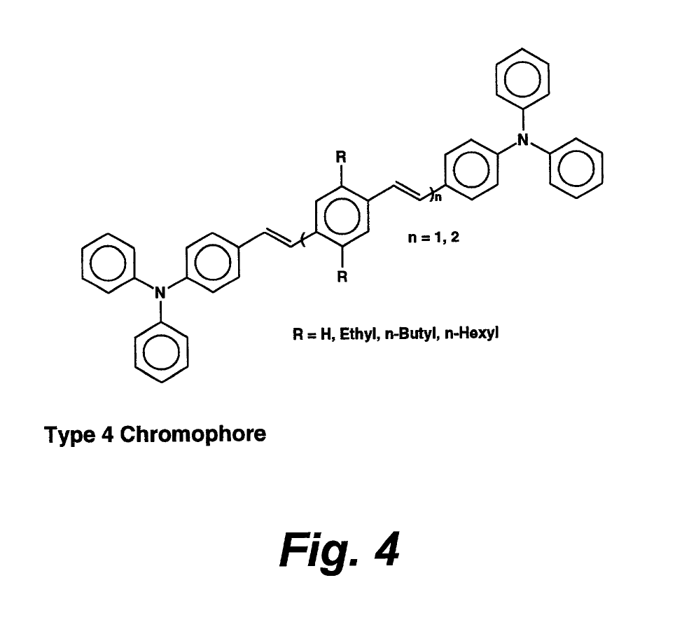

Any chromophore compound exhibiting two or three-photon absorption followed by fluorescence in the visible spectrum may be utilized in the present invention. Exemplary chromophore compounds that may be utilized according to preferred embodiments are illustrated in FIGS. 1-4. FIG. 1 illustrates a Type 1 chromophore; FIG. 2 illustrates a Type 2 chromophore; FIG. 3 illustrates a Type 3 chromophore; and FIG. 4 illustrates a Type 4 chromophore.

The chromophores may be generically identified as follows:

Type 1: Three-arm G-0 dendrimeres comprised of bis(diphenylamino)diphenylpolyene repeat units.

Type 2: Bis-(diphenylamino)diphenylpolyenes.

Type 3: Four-arm G-0 dendrimers comprised of bis-(diphenylamino)diphenylpolyene repeat units.

Type 4: Bis-(diphenylamino) substituted oligomers of poly[p-phenylene vinylene] (PPV); specifically dimers and trimers substituted with diphenylamino groups on the terminal rings, and alkyl solubilizing substituents on the internal rings.

Further, dendrimers and PPV oligomers substituted with other functional groups that display similar behavior may also be utilized according to a preferred embodiment of the present invention.

Each type of chromophore compound may be utilized alone or in combination with varying concentrations of any or all of the other types of chromophore compounds. According to a preferred embodiment, the concentration of chromophore dye in the polymer host may preferably be in the range 1-20% by weight.

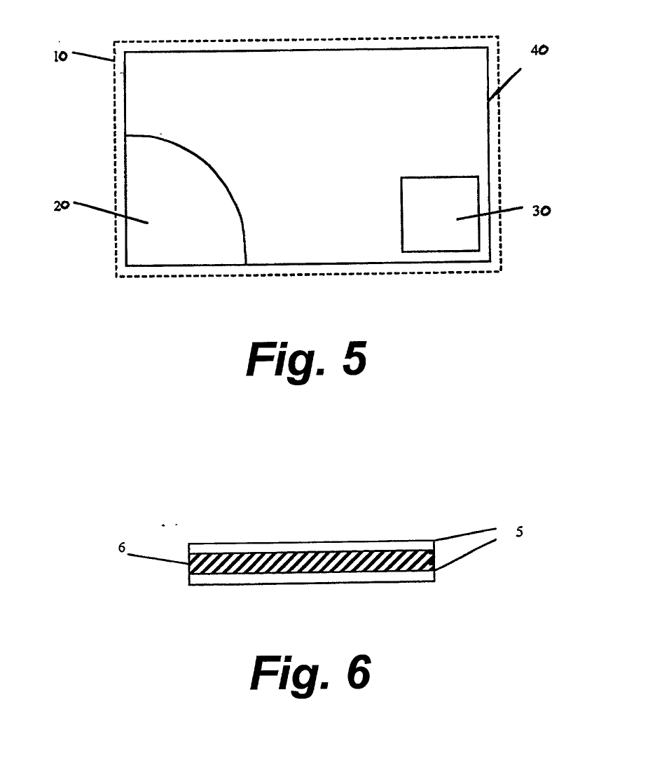

Referring to FIG. 5, an infrared detector card 10 in accordance with an exemplary embodiment of the present invention is illustrated. As depicted in FIG. 5, the infrared detector card 10 may have two distinct detector regions 20 and 30, used for different modes of operation. Each detector region 20 and 30 may comprise a polymer film containing at least one chromophore dye compound of a type described above. According to a preferred embodiment, Poly(methyl methacrylate), polystyrene, polycarbonate, and/or polymide may be used to form the polymer film. A first detector region 20 may be mostly opaque to an incident infrared laser beam due to scattering effects. Scattering increases the probability of two-photon absorption and may therefore be used to increase the sensitivity of the infrared beam detection. Scattering effects may be achieved by preparing a chromophore dye/polymer mixture that contains a scattering agent in the form of small scattering beads or micro-crystals. Such scattering agents are well known in the optical arts and may be added to the polymer/solvent mixture during the process of polymer film preparation, described below. (Suitable scattering beads are, for example, available from Polyscience under the trademark POLYBEADS.) Micro-crystals may be formed if the polymer film, prepared as described below, is additionally heated to a temperature above the polymer melting temperature (e.g., to a temperature of about 75° C. for PVB) for a predetermined time (e.g., approximately 5-10 minutes).

A second detector region 30 of the infrared detector card 10 may be transparent to an incident infrared laser beam. In order to reduce scattering effects and increase transmission in the transparent second detector region 30, the chromophore dye containing polymer film of the second detector region 30 may be pressed and heated between two transparent plates during preparation to produce an optical quality transparent medium, as described below.

In operation, the infrared detector card 10 may be placed in the path of an infrared laser beam such that the laser light is transmitted through the transparent second detector region 30 with little or no distortion. Because the laser light is not significantly scattered in the transparent second detector region 30, the two-photon excited fluorescence is less efficient in the second detector region 30 than in the more strongly scattering opaque first detector region 20. Accordingly, the transparent second detector region 30 is particularly useful for visualizing an infrared laser beam without obstructing the laser beam from reaching its intended target.

In an alternative mode of operation, the mostly opaque first detector region 20 of the infrared detector card 10 may be inserted into the path of an invisible infrared laser beam. The resulting two-photon excited florescence from the chromophore molecules will then indicate the position, shape and relative intensity of the incident infrared laser beam. Because the emission intensity (and the corresponding visually observed brightness) of the two and three-photon excited fluorescence is a proportional to the square of the peak intensity of the infrared laser pulses, the visible fluorescence is the brightest when the pulses generated by the laser are the shortest. Accordingly, if the laser loses mode-lock, the visible fluorescence will disappear. This property allows the card to be used to visually monitor the performance of mode-locked femtosecond and picosecond lasers.

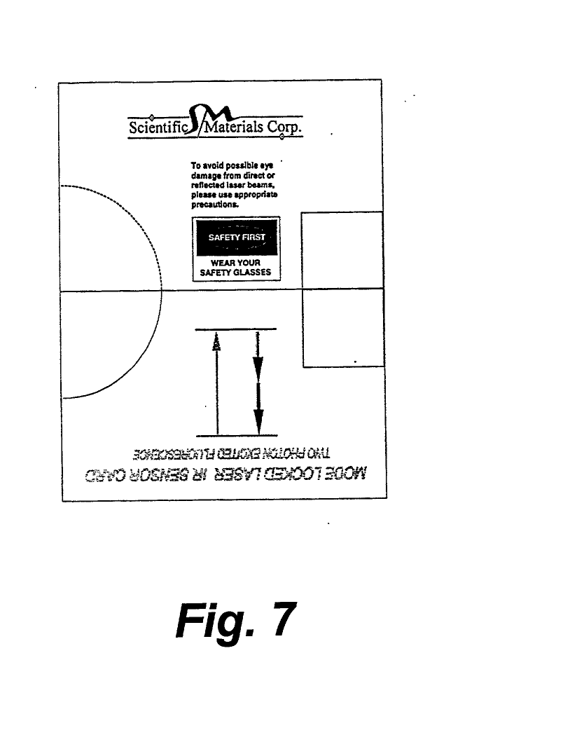

As further depicted in FIG. 5, according to another aspect of an embodiment, the infrared detection card 10 may also have a reinforcing material 40, such as cardboard, that may be optionally printed with laser safety warning information, company logos, other textual or pictorial information, or any combination thereof. An exemplary print layout is depicted in FIG. 7.

According to another alternative mode of operation, the infrared detector card 10 may be used to measure the duration of mode-locked laser pulses. Such measurement may be accomplished in conjunction with a nonlinear pulse autocorrelator apparatus. A typical nonlinear pulse autocorrelator may consists of a two-beam Michelson interferometer, where the input mode-locked laser beam is divided, preferably equally, into two beams by a preferably 50% semi-transparent beam splitter. The two beams follow different optical paths. The optical path length of one beam may be fixed, while the other path length can be varied, e.g., by translating a mirror, prism or corner reflector. The two beams may then be combined such that they spatially overlap in a nonlinear optical medium of the infrared detection card 10. Other nonlinear autocorrelator media may also be used, for example, nonlinear crystals for second harmonic generation. The changing beam path length creates a variable temporal delay between the two pulses propagating through the second harmonic crystal. Due to the quadratic dependence of the visible fluorescence on the intensity of the mode-locked infrared light, the intensity of the fluorescence is higher when the pulses overlap in time, rather than when they are separated in time. The autocorrelation measurement may be achieved by detecting the visible fluorescence intensity as a function of the temporal delay between the two beams.

FIG. 6 depicts chromophore active medium 60 sandwiched between glass plates 50 in accordance with an aspect of an exemplary method of producing chromophore dye containing polymer film.

An infrared detection card in accordance with the present invention may be produced according to the following exemplary procedure:

### EXAMPLE 1

Step 1. Dissolve a polymer in a solvent;

Step 2. Dissolve a chromophore dye in the polymer/solvent solution;

Step 3. Pour the dye/polymer/solvent solution onto a surface until the solvent substantially evaporates;

Step 4. Remove the dry polymer film from the surface; sandwich a portion of the film between transparent plates (e.g., as depicted in FIG. 6); press the film between the transparent plates while heating to a temperature below the polymer melting temperature until the pressed film sticks to the glass, providing a transparent low scattering infrared detection medium;

Step 5. Heat the remaining portion of the film to a temperature slightly above the polymer melting temperature until the dye/polymer mixture undergoes a separation of phases, forming an opaque scattering infrared detection medium; alternatively or in addition, an opaque scattering infrared detection medium may be formed according the method of steps 1-4, above, by adding scattering beads to the dye/polymer/solvent solution before evaporating the solvent;

Step 6. The opaque scattering infrared detection medium may be mounted on a substrate (e.g., cardboard, paper, or plastic) to form an infrared detection card 10; similarly, the transparent infrared detection medium may be mounted on a substrate (e.g., cardboard, paper, or plastic) to form an infrared detection card 10; in a preferred embodiment, both the opaque scattering infrared detection medium and the transparent infrared detection medium may be mounted on a single substrate (e.g., cardboard, paper, or plastic) to form an infrared detection card 10.

Step 7. The infrared detection card 10 may be laminated (e.g., with transparent polymer film 40 (FIG. 5)).

More specifically, an infrared detection card in accordance with the present invention may be produced according to the following exemplary procedure:

### EXAMPLE 2

Step 1. Dissolve approximately 1 gram of polymer polyvinyl butyral in approximately 100 mL of methylene chloride, preferably by stirring at room temperature;

Step 2. Dissolve approximately 20 mg of a chromophore dye in 100 mL of methylene chloride or pyridine; combine the dissolved dye and the polymer solution, preferably stirring the mixture until it is substantially homogeneous;

Step 3. Pour the dye/polymer solution onto a substantially flat surface (e.g., a 10 cm diameter glass dish); let the solution dry (e.g., in air or in nitrogen flow) until the solvent substantially evaporates;

Step 4. Remove the substantially dry polymer film from the substantially flat surface; the film should preferably have a thickness of approximately 0.5 mm; cut a segment (e.g., a square segment approximately 10 mm×10 mm) out the clear portion of the film; sandwich the segment between two transparent plates (e.g., square glass microscope slides), as depicted in FIG. 6; press the film between the transparent plates while heating to slightly below the polymer melting temperature (e.g., for PVB, approximately 2° C. below the 70° C. melting temperature); the pressed film will adhere to the glass, providing a transparent, low scattering optical quality transparent medium, corresponding to the second detection region 30;

Step 5. Cut the remaining film into segments (e.g., three segments) of similar shape and area; layer the segments in an at least partially overlapping manner on top of each other; press the layered segments together (e.g., between transparent plates) while heating the polymer to a temperature slightly above the melting temperature of the polymer for about five minutes; the pieces of the polymer film will stick together forming a film (preferably approximately 1.5 mm thick); heating to a temperature above the polymer melting temperature causes the dye/polymer mixture to undergo a separation of phases, in which the two-photon dye molecules crystallize out of the polymer, forming an optically non-transparent, highly scattering medium, corresponding to a first detector region 20; alternatively, an opaque scattering infrared detection medium may be formed according the method of Example 2, steps 1-4 above, by adding scattering beads to the dye/polymer/solvent solution before evaporating the solvent, eliminating the need to heat the film;

Step 6. Cut a card out of a substrate material (e.g., a rectangular card formed from thick paper, thin cardboard, or plastic) (see FIG. 7); cut out a section (e.g., a rectangular section) to accommodate the transparent detector part corresponding to the second detection region 30 and a section (e.g., a quarter-circular section) for the opaque part, corresponding to the first detector region 20 of the infrared detector card 10; position each detector region 20 and 30 in their respective cut out portions of the cardboard;

Step 7. Optionally, laminate the card from both sides with transparent polymer film 40 (FIG. 5) while maintaining each detector region 20 and 30 in their respective positions.

An infrared detection card in accordance with the present invention may also be produced according to the following exemplary procedure:

### EXAMPLE 3

According to an alternative embodiment, an infrared detection card may be formed by mixing chromophore molecules with a liquid monomer, such as styrene. The liquid monomer solution may then be solidified by any of the standard polymerization procedures, such as by thermal polymerization with or without an initiator or by using chemically initiated radical reaction, or by a combination of the above. Other polymers, such as poly-methyl-methacrylate, may also be used. The polymerization may produce the active material in the shape of the containment vessel of the liquid monomer. After polymerization, the initial form may be hot-pressed into any desired shape suitable for the detection card, such as a block, a thin film or a plate.

In a preferred embodiment, the resulting infrared laser detection card may detect infrared light at wavelengths in the range of about 750-850 nm by emitting visible light of yellow-green color at wavelengths in the range of about 500-600 nm.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but have the full scope defined by the language of the following claims, and equivalents thereof.

We claim:

1. A method of making an infrared detection medium, comprising the steps of:
dissolving a polymer and at least one chromophore dye in a solvent to form a chromophore dye/polymer/solvent mixture, wherein said at least one chromophore dye emits visible lights when irradiated with infrared light;
placing the resulting mixture onto a surface to substantially evaporate the solvent and form a substantially dry chromophore dye containing polymer film.

2. The method of making an infrared detection medium according to claim 1, wherein the at least one chromophore dye is selected from the group consisting of a Type 1 chromophore, a Type 2 chromophore, a Type 3 chromophore, and a Type 4 chromophore.

3. The method of making an infrared detection medium according to claim 2, further comprising the steps of:
pressing at least a portion of the substantially dry polymer film between first and second transparent substrates;
heating the substrates to a temperature below the polymer melting temperature until the polymer film adheres to the substrates.

4. The method of making an infrared detection medium according to claim 3, wherein the polymer is polyvinyl butyral.

5. The method of making an infrared detection medium according to claim 4, wherein the solvent is methylene chloride.

6. The method of making an infrared detection medium according to claim 2, wherein the step of dissolving a polymer and at least one chromophore dye in a solvent to form a chromophore dye/polymer/solvent mixture further comprises the steps of:
layering one or more layers of the substantially dry polymer film between first and second transparent substrates;
heating the substrates to a temperature above the polymer melting temperature until the chromophore dye/polymer mixture undergoes a separation of phases.

7. The method of making an infrared detection medium according to claim 6, wherein the polymer is polyvinyl butyral.

8. The method of making an infrared detection medium according to claim 7, wherein the solvent is methylene chloride.

9. The method of making an infrared detection medium according to claim 2, wherein the step of dissolving a polymer and at least one chromophore dye in a solvent to form a chromophore dye/polymer/solvent mixture further comprises the step of:
adding scattering beads to the chromophore dye/polymer/solvent solution.

10. The method of making an infrared detection medium according to claim 9, wherein the polymer is polyvinyl butyral.

11. The method of making an infrared detection medium according to claim 10, wherein the solvent is methylene chloride.

12. A method of making an infrared detection card having a transparent region for visibly detecting infrared radiation and an opaque region for visibly detecting infrared radiation, comprising the steps of:
forming a substantially transparent infrared detection medium;
forming a substantially opaque infrared detection medium;
mounting the substantially transparent infrared detection medium and the substantially opaque infrared detection medium on a substrate.

13. The method of making an infrared detection card having a transparent region for visibly detecting infrared radiation and an opaque region for visibly detecting infrared radiation according to claim 12, wherein the substrate includes laser safety warning information.

14. The method of making an infrared detection card having a transparent region for visibly detecting infrared radiation and an opaque region for visibly detecting infrared radiation according to claim 13, wherein the substrate comprises cardboard.

15. A method of making an infrared detection card having a transparent region for visibly detecting infrared radiation, comprising the steps of:
forming a substantially transparent infrared detection medium;
mounting the substantially transparent infrared detection medium on a substrate.

16. The method of making an infrared detection card having a transparent region for visibly detecting infrared radiation according to claim 15, wherein the substrate includes laser safety warning information.

17. The method of making an infrared detection card having a transparent region for visibly detecting infrared radiation according to claim 16, wherein the substrate comprises cardboard.

18. A method of making an infrared detection card having an opaque region for visibly detecting infrared radiation, comprising the steps of:
forming a substantially opaque infrared detection medium;
mounting the substantially opaque infrared detection medium on a substrate.

19. The method of making an infrared detection card having an opaque region for visibly detecting infrared radiation according to claim 18, wherein the substrate includes laser safety warning information.

20. The method of making an infrared detection card having an opaque region for visibly detecting infrared radiation according to claim 19, wherein the substrate comprises cardboard.

21. A method of using an infrared laser detection card having an opaque region for visibly detecting infrared radiation to detect mode-lock operation in a mode-lock infrared laser, comprising the steps of:
inserting the opaque region of the card into the beam path of the infrared laser; and
observing the opaque region of the card to determine if the laser is operating in a mode-lock state.

22. An infrared detection card having a substantially transparent region for visibly detecting infrared radiation and a substantially opaque region for visibly detecting infrared radiation, consisting of:
a substantially transparent infrared detection medium;
a substantially opaque infrared detection medium;
wherein the substantially transparent infrared detection medium and the substantially opaque infrared detection medium are mounted on a substrate.

23. The infrared detection card having a substantially transparent region for visibly detecting infrared radiation and a substantially opaque region for visibly detecting infrared radiation according to claim 22, wherein the substrate includes laser safety warning information.

24. The infrared detection card having a substantially transparent region for visibly detecting infrared radiation and a substantially opaque region for visibly detecting infrared radiation according to claim 23, wherein the substrate comprises cardboard.

25. An infrared detection card having a substantially transparent region for visibly detecting infrared radiation, consisting of:
a substantially transparent infrared detection medium;
wherein the substantially transparent infrared detection medium is mounted on a substrate.

26. The infrared detection card having a substantially transparent region for visibly detecting infrared radiation according to claim 25, wherein the substrate includes laser safety warning information.

27. The infrared detection card having a substantially transparent region for visibly detecting infrared radiation according to claim 26, wherein the substrate comprises cardboard.

28. An infrared detection card having a substantially opaque region for visibly detecting infrared radiation, consisting of:
a substantially opaque infrared detection medium;
wherein the substantially opaque infrared detection medium is mounted on a substrate.

29. The infrared detection card having a substantially opaque region for visibly detecting infrared radiation according to claim 28, wherein the substrate includes laser safety warning information.

30. The infrared detection card having a substantially opaque region for visibly detecting infrared radiation according to claim 29, wherein the substrate comprises cardboard.

31. A method of forming an infrared laser detection card, the method comprising:
combining a chromophore with monomer to form a mixture;
polymerizing the mixture to form a solid;
hot-pressing the solid to form the infrared laser detection card.

32. The method of forming an infrared laser detection card according to claim 31, wherein the chromophore is selected from the group consisting of a Type 1 chromophore, a Type 2 chromophore, a Type 3 chromophore, and a Type 4 chromophore.

33. The method of forming an infrared laser detection card according to claim 32, wherein the monomer is styrene.

34. The method of forming an infrared laser detection card according to claim 32, wherein the monomer is methyl-methacrylate.

35. A method of measuring the duration of mode-locked laser pulses, the method comprising:
projecting a mode-locked laser beam into the input of a nonlinear pulse autocorrelator apparatus for splitting the beam into two beams that follow different optical paths;
projecting the two beams onto an infrared laser detection card to illuminate at least a portion of the detection card;
detecting the visible fluorescence intensity of the illuminated portion of the detection card as a function of the temporal delay between the two beams.
